(19) United States
(12) Patent Application Publication
(10) Pub. No.: US 2018/0041493 A1
(43) Pub. Date: Feb. 8, 2018

(54) AUTHENTICATING MOBILE LOCKERS

(71) Applicant: Wal-Mart Stores, Inc., Bentonville, AR (US)

(72) Inventors: Bruce W. Wilkinson, Rogers, AR (US); Todd D. Mattingly, Bentonville, AR (US)

(21) Appl. No.: 15/669,555

(22) Filed: Aug. 4, 2017

Related U.S. Application Data
(60) Provisional application No. 62/371,443, filed on Aug. 5, 2016.

(51) Int. Cl. H04L 29/06; G06Q 10/08; G07F 17/00

(52) U.S. Cl. CPC H04L 63/08; G07F 17/0014; G06Q 10/0835

(57) ABSTRACT

In some embodiments, apparatuses and methods are provided herein useful for the storage, transportation, and delivery of items. A mobile locker is described herein that can be utilized to securely deliver items to a location for subsequent pick-up by a user. The mobile locker can include a user interface and control circuit to authenticate a user and provide secured access to the items. Advantageously, the user interface and control circuit can include a plurality of levels of authentication so that items requiring additional security can be adequately protected during transportation and storage.

### CROSS-REFERENCE TO RELATED APPLICATION

This application claims the benefit of U.S. Provisional Application No. 62/371,443, filed Aug. 5, 2016and is incorporated herein by reference in its entirety.

### TECHNICAL FIELD

This invention relates generally to storage containers and, more particularly, to portable storage containers.

### BACKGROUND

Items are commonly delivered to areas that are accessible to the public. One issue that can arise from this, however, is adequately securing the items against undesired access by people and animals. Locked mailboxes provide one solution to this issue, but these containers can commonly be dedicated to one user and would be difficult to use for many people and different locations. Keyed locking mechanisms present a similar issue in that everyone with a key has access to the items.

### BRIEF DESCRIPTION OF THE DRAWINGS

Disclosed herein are embodiments of systems, apparatuses and methods pertaining to the secure storage, transportation, and delivery of items. This description includes drawings, wherein:

FIG. 1 is a perspective view of a docking station having containers secured thereto in accordance with some embodiments.

FIG. 2 is a diagram of a container in accordance with several embodiments.

FIG. 3 is a diagram of a user interface and control circuit for a container in accordance with some embodiments.

FIG. 4 is a flowchart in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for the storage, transportation, and delivery of items. A mobile locker is described herein that can be utilized to securely deliver items to a location for subsequent pick-up by a user. The mobile locker can include a user interface and control circuit to authenticate a user and provide secured access to the items. Advantageously, the user interface and control circuit can include a plurality of levels of authentication so that items requiring additional security can be adequately protected during transportation and storage.

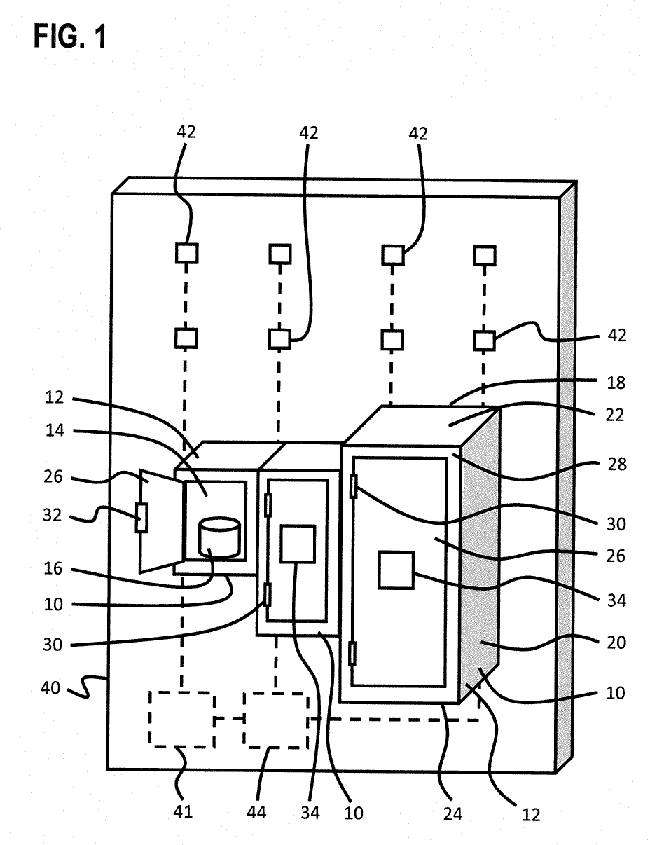

As shown in FIGS. 1-3, a mobile locker 10 includes a housing 12 with an interior 14 for the storage of items 16. In one form, the housing 12 can be generally box-shaped with a rear wall 18, side walls 20, a top wall 22, and a bottom 24 wall. A door 26 mounted to a front 28 of the housing 12 can provide selective access to the items 16 in the interior 14 thereof. The door 26 can be pivotably mounted to the housing 12 using a hinge 30 or the like. In order to securely store the items 16 within the housing 12, movement of the door 26 can be restricted by a lock mechanism 32. As shown, the locker 10 can have any suitable size to accommodate a variety of items 16.

To control access to the interior 14 of the housing 12, the locker 10 includes a user interface 34 and a control circuit 36 coupled to the user interface 34. The user interface 34 can include one or more user inputs 38 to authenticate the users prior to the control circuit 36 disabling the lock mechanism 32 and granting access to the housing interior 14. Various forms of authentication are described in more detail below.

The term control circuit as used herein refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 36 may be configured (for example, by using corresponding programming stored in a memory as will be well understood by those skilled in the art) to carry out one or more of the steps, actions, and/or functions described herein.

More specifically, the control circuit 36 can advantageously receive or retrieve product and authentication information for the items 16 stored in the locker 10 and user authentication information corresponding to the transaction for the items 16, such as from a server device or the like. Based on the product and authentication information, the control circuit 36 can require one of a plurality levels of authentication from the user to grant access to the items 16. Accordingly, the control circuit 36 can determine which one of the plurality of levels of authentication is required for access to the items 16. Upon reception of authentication from the user input 38, the control circuit 36 can determine whether the authentication from the user input matches the pre-stored authentication information for the items 16. In response to determining that the authentications match, the control circuit 36 can then unlock the lock mechanism 32 so that the user can retrieve the items 16.

As shown in FIG. 1, the locker 10 can be configured to mount or secure to a docking station 40. By one approach, the docking station 40 can be at a delivery site, so that a user can conveniently access the locker 10. In one form, the docking station 40 and locker 10 include cooperating locking components 42 so that the locker 10 can be removably secured to the docking station 40. Securing the locker 10 to the docking station 40 can be done mechanically, with keys or the like, or can be controlled by a control circuit 41 of the docking station 40 and/or the control circuit 36 of the locker 10. For example, pressing the locking components 42 of the locker 10 into engagement with the locking components 42 of the docking station 40 can cause the components 42 to engage one another and the control circuits 36, 41 can communicate. Then, when release is desired, an associate can enter a code or passphrase or other authentication information using any of the user inputs 38 described below into the docking station 40 and/or locker 10 to release the locker 10.

The docking station 40 can further include a power source 44, which can be used to supply power to the locker 10 and any electrical components therein, described in more detail below. The power source 44 can be hardwired or can be a battery or the like depending on location or preference.

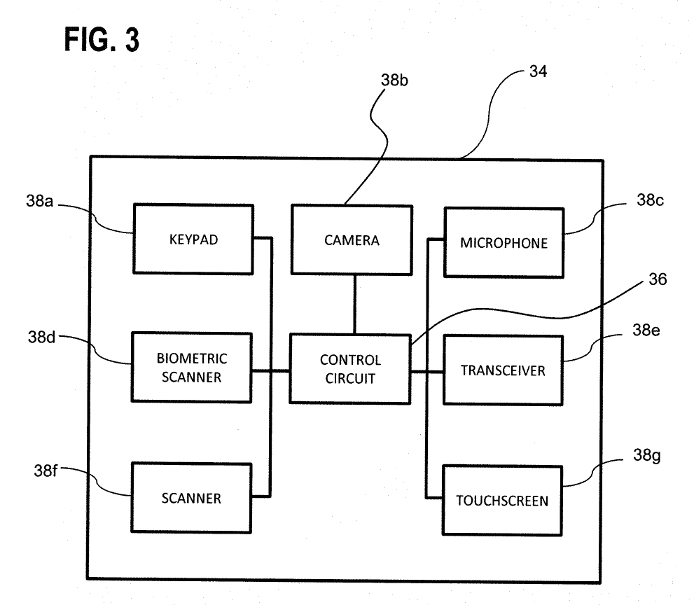

The user interface 34 can include one or more of the following user inputs 38 for authentication, as shown in FIG. 3. In a first form, the user input 38 can be a keypad 38a, whether physical buttons or a touchpad, for the user to enter a code or passphrase. In a second form, the user input 38 can be a camera 38b configured to capture an image or video of the user for authentication. In a third form, the user input 38 can be a microphone 38c configured to receive an audio input from the user, such as a code, passphrase, for verbal recognition, or the like. In a fourth form, the user input 38 can be a biometric scanner 38d, such as for a fingerprint, retina, face, cadence, wink, or the like. In a fifth form, the user input 38 can be a transceiver 38e configured to receive a transmission from a user device, such as a smartphone or other portable computing device, for authentication. In a sixth form, the user input 38 can be a scanner 38f for machine-readable codes, such as barcodes, QR codes, or the like. In a further approach, the scanner can be configured to authenticate issued identification, such as ID cards, drivers licenses, passports, and the like. In a seventh form, the user input 38 can be a touch screen 38g configured to receive a signature of the user thereon. By a further approach, the touch screen can also be used for collecting a signature from the user to confirm that the user received the items 16.

The plurality of levels of authentication can take a variety of forms. In a first form, a first level of authentication can be authentication using one of the user inputs 38 described above, a second level of authentication can be authentication using two or more of the user inputs 38, and so forth. In a second form, a first level of authentication can be authentication using one of the user inputs 38 described above and a second level of authentication can be authentication using required user inputs 38, such as valid government issued identification using the scanner to prove age for age restricted items, including alcohol, tobacco, and the like, a prescription using the scanner for prescription drugs, and so forth. So configured, the applicable level of authentication set for given items 16 can be determined based on laws of given location and/or on product risk. As such, the locker 10 can advantageously adapt to the items 16 stored therein and provide secure and authenticated access thereto. By a further form, another level of authentication can be associated with workers decoupling the locker 10 from the docking station 40.

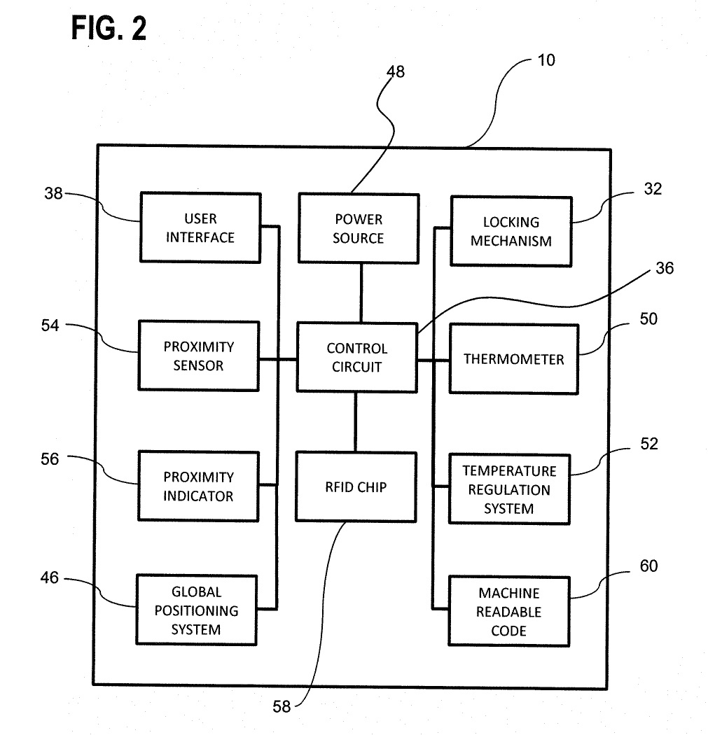

As shown in FIG. 2, the locker 10 can further include sensors and components for additional functionality. For example, the locker 10 can include a global positioning system (“gps”) or device 46 that tracks the location of the locker 10. In a first form, where the locker 10 utilizes the power source 44 of the docking station 40, the gps 46 can activate when the locker 10 is mounted to the docking station 40. This allows a user to follow the gps 46 signal for directions to the locker 10. This also indicates to the user when the locker 10 has been delivered to the docking station 40. In another form, the locker 10 can include a power source 48, in the form of a battery, solar panel, etc., that can power the gps 46 during storage and transportation. As such, the user can track the locker 10 during transport to follow the progress of delivery, as well as get directions to the location of the locker 10.

Another sensor that can be coupled or mounted to the locker 10 is a thermometer 50 configured to determine a temperature of the interior 14 and/or exterior of the locker 10. A temperature of the exterior of the locker 10 can be useful to determine whether the weather is too hot or too cold for certain items 16. Similarly, a temperature of the interior 14 of the locker 10 can be useful to determine whether the temperature is within a desired range for items 16 stored therein. For example, if the items 16 are food or other perishable items, relatively high or low temperatures may damage the items 16. Accordingly, the temperature can be tracked to avoid damage to the items 16. By a further approach, the locker 10 can include a temperature regulation system 52, which can be powered by the internal power source 48 and/or the docking station power source 44. The temperature regulation system 52 can be a cooling and/or heating system to maintain a desired temperature in the interior 14 of the locker 10. For example, for frozen items 16, the system 52 can maintain a freezing temperature in the locker 10. For other items, the system 52 can prevent the temperature in the interior from going too high or too low. In another example, the system 52 can maintain a relatively high temperature in the locker 10, such as about 140 degrees to about 180 degrees, so that the items 16 are delivered in a hot condition.

By another approach, the locker 10 can include a proximity sensor 54. The proximity sensor 54 can determine when a user approaches the locker 10 and activate any components in sleep mode. For example, the user interface 34 can go into sleep mode after a predetermined period has passed without activity and can activate in response to receiving a signal from the proximity sensor 54. If desired, the locker 10 can further include a proximity indicator 56, such as a light or the like, that operates in response to the proximity sensor 54 sensing movement. The indicator 56 can light up or flash to identify the locker 10 to the user.

The locker 10 can also include an RFID chip 58 and/or machine-readable code 60, such as a barcode, QR code, or the like, to monitor the status of the locker 10. For example, an associate can scan the RFID chip 58 and/or the machine-readable code 60 at each stage of a delivery process, such as conveying of the locker(s) 10 to a desired location within a warehouse, loading of the locker(s) 10 with the items 16, loading of the locker(s) 10 onto a delivery truck, securing the locker(s) 10 to the docking station 40, successful the items 16 have been removed from the locker(s) 10, removing the locker(s) 10 from the docking station 40, and return of the of the locker(s) 10 to the warehouse.

As shown in FIG. 1, one advantage of the lockers 10 and the docking station 40 is that the lockers 10 can have any desired size and still couple to the docking station 40. Further, the lockers 10 can be configured to secure or be daisy-chained together, as well as, to the docking station 40. Advantageously, the lockers 10 can also be configured to operate as a group. As such, if an order contains more items 16 than can be fit inside one locker 10, the order can be distributed through two or more lockers 10. Then, the lockers 10 can be secured to the docking station 40 and to one another. Next, after the user provides authentication using the methods described above according to the appropriate level of authentication using one of the user inputs 38, the control circuits 36 can cause all of the lockers 10 in the group to unlock.

So configured, the locker 10 can provide secure storage for the delivery of items 16 to convenient locations for customer pick-up. For example, docking stations 40 can be positioned adjacent to public areas, such as public transportation facilities, sports facilities, outside retail locations, and the like. Then, a consumer can order desired items 16 and select one of the docking stations 40 for pick-up. In a particular example, a consumer can order items while at the public facility and pick up the delivered items at the docking station while leaving.

In some embodiments, a mobile locker is described herein that includes a housing having an interior for storage of items for a user and configured to be removably secured to a docking station; a door of the housing configured to selectively provide access to the interior; a lock mechanism configured to restrict movement of the door; a user interface configured receive user input for authentication; and a control circuit coupled to the user interface. The control circuit is configured to: determine which one of a plurality of levels of authentication are required for access to the items to unlock the lock mechanism; retrieve authentication information associated with the items, the authentication information coinciding with the one of the plurality of levels of authentication; receive a user input at the user interface; and unlock the lock mechanism in response to determining that the user input matches the authentication information.

By some approaches, the user interface can include a camera configured to capture an image or video of the user for authentication. By several approaches, the user interface can include a microphone configured to receive an audio input from the user for authentication. By some approaches, the user interface can include a transceiver configured to receive an authentication signal from a user mobile device for authentication.

By several approaches, the plurality of levels of authentication include a first level requiring one form of authentication and a second level requiring two forms of authentication.

By some approaches, the mobile locker can further include a global positioning system such that the mobile locker can be tracked during transport and at the docking station.

By several approaches, the docking station can be configured to have a plurality of mobile lockers secured thereto, where the plurality of mobile lockers are configured to connect together. By further approaches, the control circuit can be configured to unlock the plurality of lockers in response to determining that the user input matches the authentication information.

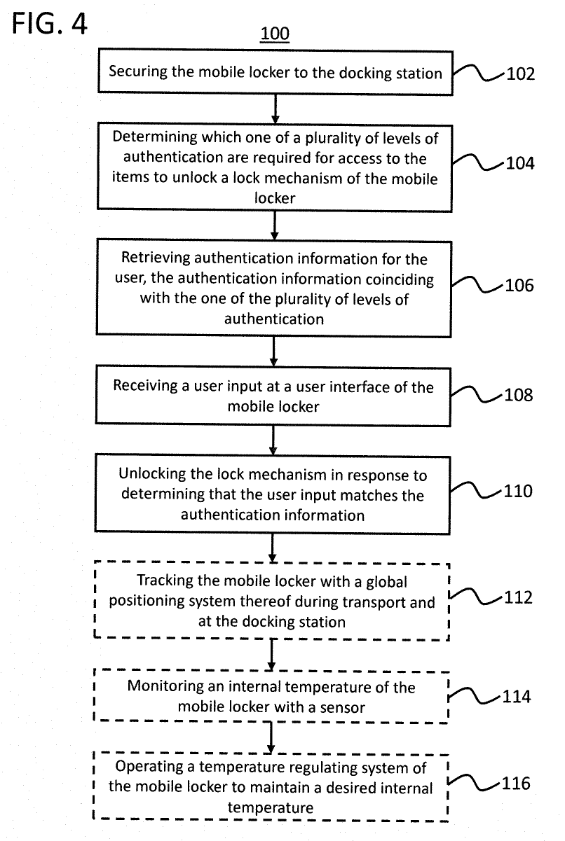

In several embodiments and as shown in FIG. 4, a method 100 for secured delivery of items within a mobile locker to a docking station for access by a user is described herein that includes: securing 102 the mobile locker to the docking station; determining 104 which one of a plurality of levels of authentication are required for access to the items to unlock a lock mechanism of the mobile locker; retrieving 106 authentication information for the user, the authentication information coinciding with the one of the plurality of levels of authentication; receiving 108 a user input at a user interface of the mobile locker; and unlocking 110 the lock mechanism in response to determining that the user input matches the authentication information.

By some approaches, receiving the user input can include recording an image or video with a camera of the user interface; receiving an audio input from the user at a microphone of the user interface; and/or receiving a signal from a mobile device associated with the user at a transceiver of the user interface.

By several approaches, the method 100 can further include tracking 112 the mobile locker with a global positioning system thereof during transport and at the docking station.

By some approaches, the method 100 can further include monitoring 114 an internal temperature of the mobile locker with a sensor; and operating 116 a cooling system of the mobile locker to maintain a desired internal temperature.

By several approaches, securing the mobile locker to the docking station can include securing a plurality of mobile lockers to the docking station and to one another; and unlocking the lock mechanism in response to determining that the user input matches the authentication information can include unlocking the lock mechanism for the plurality of mobile lockers in response to determining that the user input matches the authentication information.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A mobile locker comprising:
a housing having an interior for storage of items for a user and configured to be removably secured to a docking station;
a door of the housing configured to selectively provide access to the interior;
a lock mechanism configured to restrict movement of the door;
a user interface configured receive user input for authentication; and
a control circuit coupled to the user interface and configured to:
determine which one of a plurality of levels of authentication are required for access to the items to unlock the lock mechanism;
retrieve authentication information associated with the items, the authentication information coinciding with the one of the plurality of levels of authentication;
receive a user input at the user interface; and
unlock the lock mechanism in response to determining that the user input matches the authentication information.

2. The mobile locker of claim 1, wherein the user interface comprises a camera configured to capture an image or video of the user for authentication.

3. The mobile locker of claim 1, wherein the user interface comprises a microphone configured to receive an audio input from the user for authentication.

4. The mobile locker of claim 1, wherein the user interface comprises a transceiver configured to receive an authentication signal from a user mobile device for authentication.

5. The mobile locker of claim 1, wherein the plurality of levels of authentication include a first level requiring one form of authentication and a second level requiring two forms of authentication.

6. The mobile locker of claim 1, wherein the plurality of levels of authentication include an age authentication in response to the items being age restricted.

7. The mobile locker of claim 1, further comprising a global positioning system such that the mobile locker can be tracked during transport and at the docking station.

8. The mobile locker of claim 1, further comprising one or more sensors to monitor a status of the housing.

9. The mobile locker of claim 8, wherein the one or more sensors include a thermometer; and
further comprising a cooling system configured to maintain a temperature in the housing interior for the items.

10. The mobile locker of claim 1, further comprising a proximity sensor and a proximity indicator configured so that the proximity indicator operates in response to a user approaching the mobile locker and being sensed by the proximity sensor.

11. The mobile locker of claim 1, wherein the docking station is configured to have a plurality of mobile lockers secured thereto, the plurality of mobile lockers configured to connect together.

12. The mobile locker of claim 11, wherein the control circuit is configured to unlock the plurality of lockers in response to determining that the user input matches the authentication information.

13. A method for secured delivery of items within a mobile locker to a docking station for access by a user, the method comprising:
securing the mobile locker to the docking station;
determining which one of a plurality of levels of authentication are required for access to the items to unlock a lock mechanism of the mobile locker;
retrieving authentication information for the user, the authentication information coinciding with the one of the plurality of levels of authentication;
receiving a user input at a user interface of the mobile locker; and
unlocking the lock mechanism in response to determining that the user input matches the authentication information.

14. The method of claim 13, wherein receiving the user input comprises recording an image or video with a camera of the user interface.

15. The method of claim 13, wherein receiving the user input comprises receiving an audio input from the user at a microphone of the user interface.

16. The method of claim 13, wherein receiving the user input comprises receiving a signal from a mobile device associated with the user at a transceiver of the user interface.

17. The method of claim 13, wherein the plurality of levels of authentication include a first level requiring one form of authentication information and a second level requiring two forms of authentication information.

18. The method of claim 13, further comprising tracking the mobile locker with a global positioning system thereof during transport and at the docking station.

19. The method of claim 13, further comprising:
monitoring an internal temperature of the mobile locker with a sensor; and
operating a temperature regulating system of the mobile locker to maintain a desired internal temperature.

20. The method of claim 13, wherein securing the mobile locker to the docking station comprises securing a plurality of mobile lockers to the docking station and to one another; and unlocking the lock mechanism in response to determining that the user input matches the authentication information comprises unlocking the lock mechanism for the plurality of mobile lockers in response to determining that the user input matches the authentication information.
